(19) United States
(12) Patent Application Publication
(10) Pub. No.: US 2025/0299887 A1
(43) Pub. Date: Sep. 25, 2025

(54) MULTILAYER CERAMIC ELECTRONIC COMPONENT AND METHOD FOR MANUFACTURING MULTILAYER CERAMIC ELECTRONIC COMPONENT

(71) Applicant: TAIYO YUDEN CO., LTD., Tokyo (JP)

(72) Inventor: Takayuki GOTO, Takasaki-shi (JP)

(21) Appl. No.: 19/080,075

(22) Filed: Mar. 14, 2025

(30) Foreign Application Priority Data
Mar. 22, 2024 (JP) 2024-047344

(51) Int. Cl. H01G 4/30; H01G 4/008; H01G 4/12

(52) U.S. Cl. CPC H01G 4/30; H01G 4/0085; H01G 4/1227

(57) ABSTRACT

A multilayer ceramic electronic component includes a laminate body including dielectric layers containing barium titanate and copper, and internal electrode layers and intermediate regions containing nickel and copper. The intermediate region are each arranged between the dielectric layers and the internal electrode layers, respectively. The metal concentration A (at %) of nickel in each intermediate region is 3 at %<A<50 at % whereas a metal concentration B (at %) of nickel in each of the internal electrode layer is A<B. When D12 (at %), D11 (at %), and D40 (at %) are the average metal concentration of copper in the internal electrode layers, in the dielectric layers, and in the intermediate regions, respectively, the following relationships are satisfied: D12>D11, D11<D40, 0.1 at %<D12≤35 at %, and 0.01 at %<D11<5 at %.

### CROSS REFERENCES TO RELATED APPLICATION

The present application claims priority to Japanese Patent Application No. 2024-047344, filed Mar. 22, 2024, the disclosure of which is incorporated herein by reference in its entirety including any and all particular combinations of the features disclosed therein.

### BACKGROUND OF THE INVENTION

### 1. Field of the Invention

The present disclosure relates to a multilayer ceramic electronic component and a method for manufacturing a multilayer ceramic electronic component.

### 2. Description of the Related Art

In recent years, with the progress of IT equipment, the evolution of cloud services and communication standards has developed remarkably, and the demand for electronic components, such as multilayer ceramic capacitors, which are core components of the electronic industry, has increased significantly. Under such circumstances, it is required to increase the non-defective rate while maintaining a high capacitance by maintaining the basic performance, such as dielectric constant and insulating property of electronic components.

Japanese Unexamined Patent Application Publication No. 2023-106310 discloses a multilayer electronic component having excellent flexural resistance and suppresses the occurrence of radial cracks. The multilayer electronic component includes a main body and external electrodes. The main body includes dielectric layers and internal electrodes laminated in a first direction with the dielectric layers interposed therebetween. Each external electrode includes a first electrode layer and a second electrode layer. The first electrode layer is connected to the internal electrodes and contains Ni. The second electrode layer is disposed on the first electrode layer and contains a Ni—Cu alloy. The amount of Cu contained in the second electrode layer is 70 mol to 90 mol based on 100 mol of the total amount of Ni and Cu.

### SUMMARY OF THE INVENTION

An object of the present disclosure to provide a multilayer ceramic electronic component in which acoustic noise is inhibited while maintaining a high capacitance.

The present disclosure provides a multilayer ceramic electronic component that includes a laminate body including a plurality of dielectric layers laminated along a first axis, a plurality of internal electrode layers each disposed between adjacent dielectric layers of the plurality of dielectric layers along the first axis, and intermediate regions each disposed between the dielectric layers and the internal electrode layers, respectively. Each of the plurality of dielectric layers contains barium titanate and copper. The plurality of internal electrode layers and the intermediate regions each contain nickel and copper. The metal concentration A (at %) of nickel in each of the intermediate regions is 3 at %<A<50 at % whereas a metal concentration B (at %) of nickel in each of the internal electrode layer is A<B. The following relationships are satisfied: D12>D11, and D11<D40 where D12 (at %) is the average metal concentration of copper in the plurality of internal electrode layers, D11 (at %) is the average metal concentration of copper in the plurality of dielectric layers, and D40 (at %) is the average metal concentration of copper in the intermediate regions, and D12 is 0.1 at %<D12≤35 at %, and D11 is 0.01 at %<D11<5 at %.

### Effects of the Invention

According to some embodiments, a multilayer ceramic electronic component in which acoustic noise is inhibited while maintaining a high capacitance can be obtained. For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 is a perspective view of a multilayer ceramic capacitor according to an embodiment of the present disclosure;

FIG. 2 is a cross-sectional view of the multilayer ceramic capacitor taken along line A-A of FIG. 1;

FIG. 3 is a cross-sectional view of the multilayer ceramic capacitor taken along line B-B of FIG. 1;

FIG. 4 is a cross-sectional view illustrating details of an element body according to an embodiment of the present disclosure;

FIG. 5 is a flowchart of a method for manufacturing a multilayer ceramic capacitor according to an embodiment of the present disclosure;

FIGS. 6A and 6B illustrate an example of a method for manufacturing a multilayer ceramic capacitor according to an embodiment of the present disclosure;

FIG. 7A is a schematic partial cross-sectional view of the multilayer ceramic capacitor manufactured in Example 1, and FIG. 7B is a graph of the average metal concentrations (at %) of various metals, determined by line analysis using TEM-EDS on the cross-section;

FIG. 8A is a graph of the average metal concentrations (at %) of various metals, determined by line analysis using TEM-EDS on the cross-section of the multilayer ceramic capacitor manufactured in Example 1; and

FIG. 8B is an enlarged graph of region M in the graph of FIG. 8A.

### DESCRIPTION OF THE PREFERRED EMBODIMENTS

When an electric charge is applied to a multilayer ceramic capacitor, which is an embodiment of a multilayer ceramic electronic component, an electrostrictive effect occurs in dielectric layers in an electric charge application direction perpendicular to internal electrode layers and the dielectric layers. In addition, due to the Poisson's ratio of the ceramic which is a dielectric, the electrostrictive effect also occurs in a direction perpendicular to the electric charge application direction and parallel to the internal electrode layers and the dielectric layers. Due to these electrostrictive effects, the component vibrates when driven by alternating voltage, disadvantageously causing acoustic noise. For an excessively vibrating capacitor, stress occurs at the contact points between the element body, which is a strained portion, and the cover layer, the side margin portion, the end margin portion, and so forth, which are non-strained portions, and cracks are formed from the contact points, disadvantageously causing a decrease in capacitance and a failure.

The inventors have conducted intensive studies and have found the following: By controlling the copper concentration in internal electrode layers and the copper concentration in dielectric layers, dense intermediate regions are formed between the internal electrode layers and the dielectric layers. The formation of these intermediate regions increases rigidity around the internal electrode layers to make it possible to effectively inhibit strain that occurs mainly in a direction perpendicular to an electric charge application direction. As a result, it is possible to provide a multilayer ceramic electronic component in which the occurrence of acoustic noise and cracking is inhibited while maintaining high capacitance.

That is, an embodiment of the present invention provides a multilayer ceramic electronic component including:
a laminate body including:
   a plurality of dielectric layers laminated along a first axis,
   a plurality of internal electrode layers each arranged between adjacent dielectric layers of the plurality of dielectric layers along the first axis, and
   intermediate regions each arranged between the dielectric layers and the internal electrode layers, respectively,
wherein each of the plurality of dielectric layers contains barium titanate and copper,
the plurality of internal electrode layers and the intermediate regions each contain nickel and copper,
the metal concentration A (at %) of nickel in each of the intermediate regions is 3 at %<A<50 at % whereas a metal concentration B (at %) of nickel in each of the internal electrode layer is A<B,
wherein the following relationships are satisfied:

$$D 12 > D 11 , and D 11 < D 40$$

where D12 (at %) is the average metal concentration of copper in the plurality of internal electrode layers, D11 (at %) is the average metal concentration of copper in the plurality of dielectric layers, and D40 (at %) is the average metal concentration of copper in the intermediate regions, and

$$D 12 is 0.1 at \% < D 12 \leq 35 at \% , and D 11 is 0.01 at \% < D 11 < 5 at \% .$$

Embodiments of the present disclosure will be described in detail, but the present disclosure is not limited thereto. It should be noted that in this specification and the drawings, components having substantially the same functional configuration are denoted by the same reference numerals, and redundant description thereof may be omitted. The X-, Y-, and Z-axes mutually orthogonal are presented in the drawings. The X-axis, Y-axis, and Z-axis define a fixed coordinate system that is fixed with respect to a multilayer ceramic capacitor, which is an example of a multilayer ceramic electronic component. When the external shape of a multilayer ceramic capacitor, which is an example of a multilayer ceramic electronic component, is a roughly rectangular parallelepiped, the X-axis, Y-axis, and Z-axis can correspond to the length, width, and height of the multilayer ceramic capacitor. The multilayer ceramic electronic component according to an embodiment will be described below using a multilayer ceramic capacitor as an example of the multilayer ceramic electronic component.

### Multilayer Ceramic Capacitor

### Structure of Multilayer Ceramic Capacitor

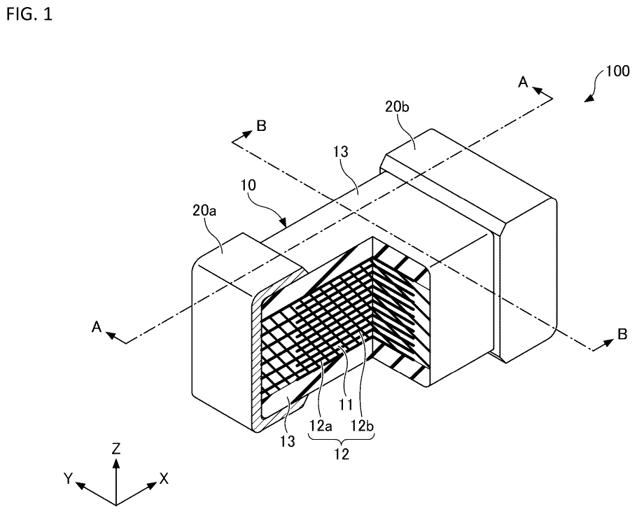

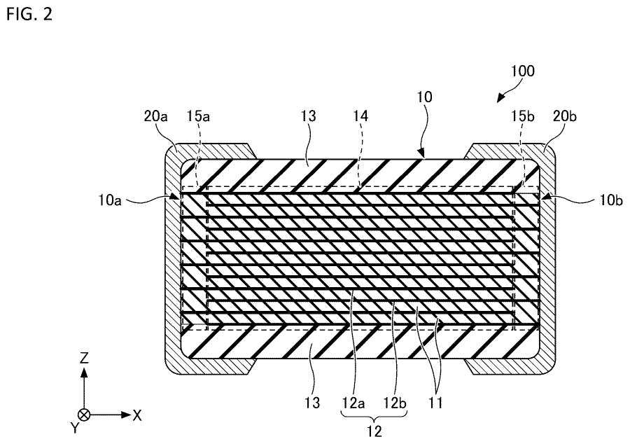

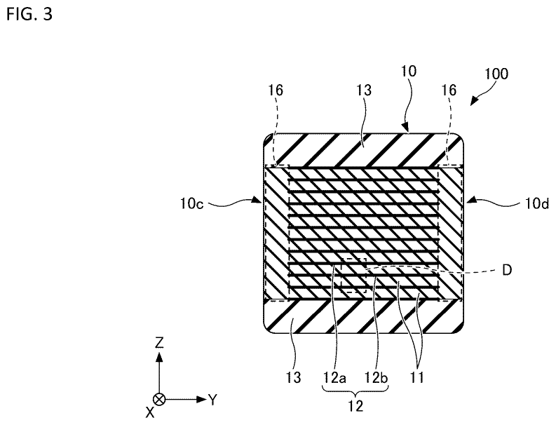

FIG. 1 is a perspective view of a multilayer ceramic capacitor according to an embodiment of the present disclosure. FIG. 2 is a cross-sectional view of the multilayer ceramic capacitor taken along line A-A of FIG. 1. FIG. 3 is a cross-sectional view of the multilayer ceramic capacitor taken along line B-B of FIG. 1.

As illustrated in FIGS. 1 to 3, the multilayer ceramic capacitor 100 includes an element body 10 having a roughly rectangular parallelepiped shape. In the element body 10, two opposing faces of the faces are referred to as an upper face and a lower face, and the four faces connecting the upper face and the lower face are referred to as side faces. Usually, when the multilayer ceramic capacitor is mounted on a circuit board, the face facing the board is referred to as the lower face, but the embodiment is not limited thereto. In the examples of FIGS. 1 to 3, a first external electrode 20a and a second external electrode 20b are disposed on a first side face 10a and a second side face 10b, respectively, which are two opposing side faces of the element body 10 (see FIG. 2). The first external electrode 20a extends from the first side face 10a to the four adjacent faces. The second external electrode 20b extends from the second side face 10b to the four adjacent faces. However, the first external electrode 20a and the second external electrode 20b are spaced apart from each other. The external electrodes may be disposed on any face of the element body 10, not limited to the two opposing side faces.

The lamination direction in which dielectric layers 11 and internal electrode layers 12 are laminated is a first axis. In FIGS. 1 to 3, the first axis, which is the lamination direction of the internal electrode layers 12 and the dielectric layers 11, is the Z-axis, which is the direction in which the internal electrode layers are opposite each other.

An axis perpendicular to the first axis, which is the lamination direction, is a second axis. In FIGS. 1 to 3, the second axis, which is perpendicular to the first axis extending in the lamination direction, is the X-axis. The second axis is along the longitudinal direction of the element body 10, and is an axis along the direction in which the first side face 10a and the second side face 10b of the element body 10 are opposite each other, and along the direction in which the first external electrode 20a and the second external electrode 20b are opposite each other.

An axis that is perpendicular to the first axis extending in the lamination direction and perpendicular to the second axis is a third axis. The third axis is an axis along the width of the internal electrode layer 12. In FIGS. 1 to 3, the third axis, which is perpendicular to the first axis extending in the lamination direction and perpendicular to the second axis, is the Y-axis, which is the axis extending in the direction in which a third side face 10c and a fourth side face 10d, which are the two side faces other than the first side face 10a or the second side face 10b, of the four side faces of the element body 10, are opposite each other (see FIG. 3). The X-, Y-, and Z-axes are mutually orthogonal.

The lamination direction is not limited to the Z-direction, but may be any direction. Thus, for example, the first axis, which is the lamination direction, may be the X-axis in the X-direction or the Y-axis in the Y-direction.

In this specification, in order to explain a general embodiment, a figure illustrating a specific embodiment may be used. The content explained in the coordinate system used in an embodiment is applied in the general embodiment by interpreting it in a general coordinate system with the lamination direction as the first axis. For example, the X-axis, Y-axis, and Z-axis used in FIGS. 1 to 3 in which the lamination direction coincide with the Z-direction as a specific embodiment can be read as the second axis, third axis, and first axis in a general embodiment.

The element body 10 has a configuration in which the internal electrode layers 12 and the dielectric layers 11 containing a ceramic material that functions as a dielectric are alternately laminated. The internal electrode layers 12 include a plurality of first internal electrode layers 12a and a plurality of second internal electrode layers 12b. The first internal electrode layers 12a and the second internal electrode layers 12b are alternately laminated. An edge of the first internal electrode layer 12a is extracted to the surface of the element body 10 on which the first external electrode 20a is disposed, that is, to the first side face 10a in the examples of FIGS. 1 to 3. An edge of the second internal electrode layer 12b is extracted to the surface of the element body 10 on which the second external electrode 20b is disposed, that is, to the second side face 10b in the examples of FIGS. 1 to 3. Thereby, the first internal electrode layers 12a and the second internal electrode layers 12b are alternately electrically connected to the first external electrode 20a and the second external electrode 20b. Thus, the multilayer ceramic capacitor 100 has a configuration in which capacitor units are laminated. In a laminate body of the internal electrode layers 12 and the dielectric layers 11, the internal electrode layers 12 are arranged on the outermost layers in the lamination direction. The outer faces of the laminate body in the lamination direction, in the examples of FIGS. 1 to 3, the upper and lower faces, are covered with cover layers 13. The cover layer 13 is mainly composed of a ceramic material. For example, the cover layer 13 may have the same composition as the dielectric layer 11 or may have a different composition. It should be noted that as long as the first internal electrode layer 12a and the second internal electrode layer 12b are exposed in different areas on the surface of the laminate body and are electrically connected to different external electrodes, the configuration is not limited to those illustrated in FIGS. 1 to 3. The different areas on the surface of the laminate body may be surface areas on opposing faces of the laminate body, surface areas on adjacent faces of the laminate body, or different surface areas on the same face of the laminate body. As long as the different external electrodes are spaced apart from each other, the first internal electrode layer 12a and the second internal electrode layer 12b may each extend from a face exposed in the surface region of the laminate body to another face.

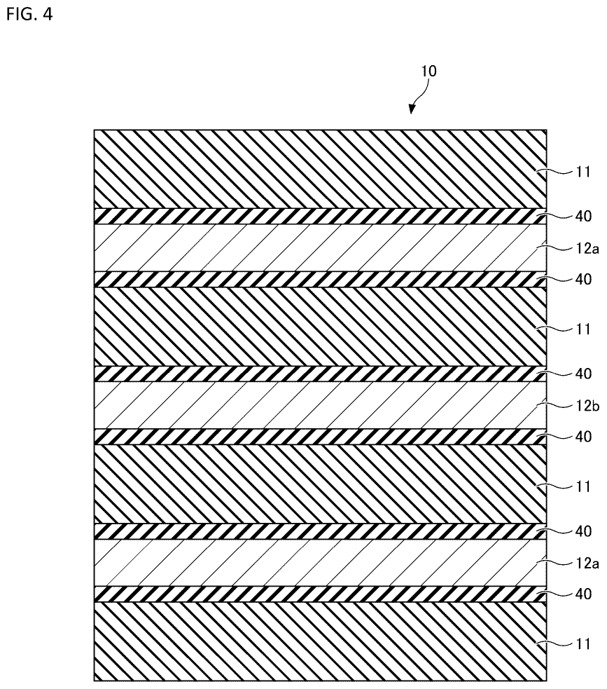

Although details will be described below, the element body 10 includes a plurality of intermediate regions 40 (see FIG. 4) between the dielectric layers 11 and the internal electrode layers 12. In FIGS. 1 to 3, the intermediate regions 40 are omitted. The element body 10 can be regarded as a laminate body having the plurality of dielectric layers laminated along the first axis, the plurality of internal electrode layers each disposed between adjacent dielectric layers along the first axis, and the intermediate regions arranged between the dielectric layers and the internal electrode layers.

The size of the multilayer ceramic capacitor 100 is not particularly limited, and may be, for example, 0.25 mm in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the sizes of the multilayer ceramic capacitor 100 listed above are merely examples, and the multilayer ceramic capacitor is not limited to the sizes listed above. The size of the multilayer ceramic capacitor 100 may be, for example, length>width≥height, width>length≥height, height>length≥width, or height>width≥length. For example, the length represents the size in the X-axis direction, the width represents the size in the Y-axis direction, and the height represents the size in the Z-axis direction.

As described above, the multilayer ceramic capacitor 100 of the present embodiment has the plurality of dielectric layers 11 laminated along the Z-axis, which is the first axis, and the plurality of internal electrode layers 12 each disposed between adjacent dielectric layers 11 along the first axis. Furthermore, the multilayer ceramic capacitor 100 of the present embodiment includes the intermediate regions 40 disposed between the internal electrode layers 12 and the dielectric layers 11.

The internal electrode layers 12, the dielectric layers 11, and the intermediate regions 40 will be described below.

### Internal Electrode Layer

As illustrated in FIG. 2, the region where each of the first internal electrode layers 12a connected to the first external electrode 20a and a corresponding one of the second internal electrode layers 12b connected to the second external electrode 20b are opposite each other is a region where electrical capacitance is generated in the multilayer ceramic capacitor 100. The region that generates the electrical capacitance is referred to as a capacitive part 14. That is, the capacitive part 14 is a region where adjacent internal electrode layers connected to different external electrodes are opposite each other with a dielectric layer interposed therebetween.

The region where the first internal electrode layers 12a connected to the first external electrode 20a are opposite each other in the lamination direction without the second internal electrode layer 12b connected to the second external electrode 20b being interposed therebetween is referred to as a first end margin portion 15a. Also, the region where the second internal electrode layers 12b connected to the second external electrode 20b are opposite each other in the lamination direction without the first internal electrode layer 12a connected to the first external electrode 20a being interposed therebetween is referred to as a second end margin portion 15b. Each end margin portion is a region where internal electrode layers connected to the same external electrode are opposite each other in the lamination direction without any internal electrode layers connected to different external electrodes therebetween. The first end margin portion 15a and the second end margin portion 15b are regions that do not generate electrical capacitance.

Side margin portions 16 are regions provided outside the capacitive part 14 in the third axis perpendicular to the lamination direction and perpendicular to the second axis, that is, in the example of FIG. 3, in the direction along the Y-axis. That is, the side margin portions 16 are outer regions adjacent to the capacitive part 14 when viewed from the lamination direction, and are outer regions adjacent to the capacitive part 14 on the side where the internal electrode layers 12 are not extracted. The side margin portions 16 are also regions that do not generate electrical capacitance.

The internal electrode layers 12 are each disposed between adjacent dielectric layers along the first axis and contain nickel (Ni) and copper (Cu).

The average metal concentration D12 (at %) of copper in the internal electrode layers 12 is 0.1 at %<D12≤35 at %.

When the average metal concentration D12 of copper in the internal electrode layers 12 is 0.1 at % or less, the copper concentration in the vicinity of the internal electrode layers 12 obtained by copper diffusion is insufficient, and the effect of improving the rigidity due to the densification of the internal electrode layers 12 cannot be provided. At more than 35 at %, the magnetic properties of the internal electrode layers 12 decrease, resulting in poor handling in the alignment step using a magnetic field in the manufacture of multilayer ceramic capacitors.

The average metal concentration D12 (at %) of copper in the internal electrode layers 12 is preferably 1 at %≤D12≤30 at %, more preferably 1 at %≤D12≤20 at %, and still more preferably 1 at %≤D12≤10 at %.

The average metal concentration D12 of copper in the internal electrode layers 12 can be determined by line analysis using energy dispersive X-ray spectroscopy (EDS) of a transmission electron microscope (TEM) as described below (TEM-EDS analysis).

In the example illustrated in FIGS. 1 and 2, the first axis, which is the lamination direction, is the Z-axis direction. Thus, this is an example in which the multilayer ceramic capacitor 100 is polished along a direction perpendicular to the Y-axis, which is the third axis, to expose the XZ plane on which the internal electrode layers 12 and the dielectric layers 11 are laminated. On the exposed XZ plane, a set of the internal electrode layers 12 and the dielectric layers 11 located at the third to tenth layers counted from the end of the upper face along the Z-axis, which is the first axis, a set of a total of 10 layers of the internal electrode layers 12 and the dielectric layers 11 located in the center, and a set of the internal electrode layers 12 and the dielectric layers 11 located at the third to tenth layers counted from the end of the lower face are selected.

In each of the set of the internal electrode layers 12 and the dielectric layers 11 located at the third to tenth layers counted from the end of the upper face along the Z-axis, which is the first axis, the set of a total of 10 layers of the internal electrode layers 12 and the dielectric layers 11 located in the center, and the set of the internal electrode layers 12 and the dielectric layers 11 located at the third to tenth layers counted from the end of the lower face, three measurement portions are properly or randomly selected within a range of 70% from the center along the X-axis toward the side edges, which is the second axis, in such a manner that the center-to-center distance between the nearest measurement portions is 30 to 100 μm. Then, line analysis is performed using TEM-EDS along the Z-axis at each measurement portion to measure the metal concentration (at %) of copper (Cu) on the line. It should be noted that each measurement portion is selected from within the capacitive part 14. The size of each measurement portion is 1.0 to 3.0 μm square.

In each measurement portion, for each internal electrode layer 12 whose cross-section can be observed in its entirety, the metal concentrations of copper in the internal electrode layer 12 are measured at evenly spaced intervals in a range of 70% from the center of the internal electrode layer 12 toward the top/bottom edges in the direction along the Z-axis, which is the first axis, and the measured values are averaged. The resulting average value is defined as the average metal concentration of copper in the internal electrode layers 12 in the measurement portion. The average value of the metal concentrations of copper in the internal electrode layers 12 in all the measurement portions is defined as the average metal concentration D12 (at %) of copper in the internal electrode layers 12 in the multilayer ceramic capacitor 100.

The internal electrode layers 12 may contain nickel as a main component. The internal electrode layers 12 contain nickel and thus have excellent electrical properties and lead to cost reduction.

Furthermore, since the internal electrode layers 12 contain copper, dense intermediate regions can be formed around the internal electrode layers, and the rigidity of the internal electrode layers 12 can be increased. Increasing the rigidity of the internal electrode layers 12 can inhibit the electrostriction that occurs mainly in a direction perpendicular to an electric charge application direction, and cracking caused mainly by this electrostriction can be inhibited. The use of such a structure can provide a multilayer ceramic electronic component in which acoustic noise is inhibited while maintaining a high capacitance.

The internal electrode layers 12 may contain components used in internal electrode layers of multilayer ceramic capacitors in addition to nickel and copper. The internal electrode layers 12 may contain, in particular, a base metal, such as tin (Sn), or an alloy containing them. The internal electrode layers 12 may contain a noble metal, such as platinum (Pt), palladium (Pd), silver (Ag), or gold (Au), or an alloy containing them.

The main component in the first internal electrode layer 12a and the main component in the second internal electrode layer 12b may be the same or different. As an example, the main component of the first internal electrode layer 12a and the second internal electrode layer 12b is nickel.

### Thickness of Internal Electrode Layer

The thickness of each internal electrode layer 12 is preferably, but not necessarily, for example, 0.5 μm or less, more preferably 0.4 μm or less, from the viewpoint of enabling an increase in the laminated number of layers to increase the capacitance while reducing the size of the multilayer ceramic capacitor 100.

The thickness of the internal electrode layer 12 can be 0.4 μm or more, for example, when the internal electrode layer 12 is formed by applying a metal conductive paste that is an internal electrode layer slurry by a printing method, such as screen printing or gravure printing. For example, when the internal electrode layer 12 is formed by a thin film process, such as sputtering or vapor deposition, the thickness of the internal electrode layer 12 can be 0.1 μm or more, which is thinner than that achieved by the printing method.

The thickness of each of the internal electrode layers 12 is evaluated in a cross-section including the first axis parallel to the lamination direction. For ease of polishing and measurement, it is preferable to evaluate the thickness at either a cross-section that further includes the second axis perpendicular to the lamination direction, or a cross-section that further includes the third axis perpendicular to the lamination direction and also perpendicular to the second axis. For the former, the ceramic capacitor 100 is polished in the direction of the third axis. For the latter, the ceramic capacitor 100 is polished in the direction of the second axis. The thickness of each of the five layers (when the number of layers of the internal electrode layers 12 is an even number, six layers may be used at the center) located in each of the center, the upper end, and the lower end of the exposed internal electrode layers 12 in the direction of the first axis is measured at three locations: the middle portion, the left side, and the right side of each layer. These measurements are used to define the thickness of each internal electrode layer 12. The average of all measurements can be defined as the thickness of each internal electrode layer 12.

In the example illustrated in FIGS. 1 and 2, the first axis, which is the lamination direction, is the Z-axis direction. Thus, this is an example in which the multilayer ceramic capacitor 100 is polished along the Y-axis, which is the third axis, to expose the XZ plane on which the internal electrode layers 12 and the dielectric layers 11 are laminated. On the exposed XZ plane, five layers (when the number of the internal electrode layers 12 is an even number, six layers may be used) of the internal electrode layers 12 located in the center along the first axis, which is the Z-axis, and five layers of the internal electrode layers 12 located in each of the upper end and the lower end along the first axis, which is the Z-axis, are selected. At this time, the internal electrode layers 12 are selected from within the capacitive part 14.

Then, for each of the selected internal electrode layers 12, the thickness is measured at three locations along the X-axis, which is the second axis, namely, ¼, ½, and ¾ of the length of the X-axis, and the average value can be defined as the thickness of each internal electrode layer 12. Using the same procedure, the thicknesses of all the selected internal electrode layers 12 are measured, and the average value of the measurements can be defined as the thickness of each internal electrode layers 12 in the evaluated multilayer ceramic capacitor 100.

For each of the selected internal electrode layers 12, the thickness is measured at the center along the X-axis, which is the second axis, and the measured value is used as the thickness of the internal electrode layer 12. Using the same procedure, the thicknesses of all the selected internal electrode layers 12 are measured, and the average value of the measurements is calculated. The resulting average value can be defined as the thickness of each internal electrode layer 12 in the multilayer ceramic capacitor 100.

### Dielectric Layer

The dielectric layers 11 are laminated along the first axis.

Each of the dielectric layers 11 contains barium titanate (BaTiO₃) and copper (Cu).

Barium titanate has excellent dielectric properties, such as an extremely high dielectric constant and low dielectric loss. The average metal concentration D11 (at %) of copper in the dielectric layers 11 is 0.01 at %<D11<5 at %, and D12>D11, where D12 is the average metal concentration (at %) of copper contained in the internal electrode layers 12. When D12≤D11, copper near the internal electrode layers 12 containing nickel reacts with nickel to form an alloy, causing the copper concentration in the intermediate regions 40 to be lower than the copper concentration in the dielectric layers 11. This may reduce the rigidity of the internal electrode layers 12. When the copper concentration in the dielectric layers 11 is increased for the purpose of ensuring the denseness of the intermediate regions 40, the capacitance may be reduced.

When the average metal concentration D11 of copper in the dielectric layer 11 is 0.01 at % or less, the denseness of the dielectric layers 11 may be reduced. At 5 at % or more, the denseness of the whole of the dielectric layers may be increased to reduce the dielectric constant. Copper may be dissolved in the dielectric layers to easily cause oxygen defects. This leads to a reduction in insulating property to an increase in leakage current, making it difficult to maintain a required voltage.

The average metal concentration D11 (at %) of copper in the dielectric layers 11 is preferably 0.1 at %≤D11≤3 at %, more preferably 0.1 at %≤D11≤1 at %.

The average metal concentration D11 of copper in the dielectric layers 11 can be determined as described below.

In the example illustrated in FIGS. 1 and 2, the first axis, which is the lamination direction, is the Z-axis direction. Thus, this is an example in which the multilayer ceramic capacitor 100 is polished along a direction perpendicular to the Y-axis, which is the third axis, to expose the XZ plane on which the internal electrode layers 12 and the dielectric layers 11 are laminated. On the exposed XZ plane, the set of the internal electrode layers 12 and the dielectric layers 11 located at the third to tenth layers counted from the end of the upper face along the Z-axis, which is the first axis, the set of a total of 10 layers of the internal electrode layers 12 and the dielectric layers 11 located in the center, and a set of the internal electrode layers 12 and the dielectric layers 11 located at the third to tenth layers counted from the end of the lower face are selected.

In each of the set of the internal electrode layers 12 and the dielectric layers 11 located at the third to tenth layers counted from the end of the upper face along the Z-axis, which is the first axis, the set of a total of 10 layers of the internal electrode layers 12 and the dielectric layers 11 located in the center, and the set of the internal electrode layers 12 and the dielectric layers 11 located at the third to tenth layers counted from the end of the lower face, three measurement portions are properly or randomly selected within a range of 70% from the center along the X-axis toward the side edges, which is the second axis, in such a manner that the center-to-center distance between the nearest measurement portions is 30 to 100 μm. Then, line analysis is performed using TEM-EDS along the Z-axis at each measurement portion to measure the metal concentration (at %) of copper (Cu) on the line. It should be noted that each measurement portion is selected from within the capacitive part 14. The size of each measurement portion is 1.0 to 3.0 μm square.

In each measurement portion, for each the dielectric layer 11 whose cross-section can be observed in its entirety, the metal concentrations of copper in the dielectric layer 11 are measured at evenly spaced intervals in a range of 70% from the center of the dielectric layer 11 toward the top/bottom edges in the direction along the Z-axis, which is the first axis, and the measured values are averaged. The resulting average value is defined as the average metal concentration of copper in the dielectric layer 11 in the measurement portion. The average value of the metal concentration of copper in the dielectric layers 11 in all the measurement portions is defined as the average metal concentration D11 (at %) of copper in the dielectric layers 11 in the multilayer ceramic capacitor 100.

The dielectric layers 11 may contain an additive as an optional component.

Examples of the additive that can be contained in the dielectric layers 11 include, but are not particularly limited to, oxides containing one or more elements selected from the group consisting of zirconium (Zr), magnesium (Mg), molybdenum (Mo), manganese (Mn), vanadium (V), chromium (Cr), rare-earth elements, such as scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb); oxides containing one or more elements selected from the group consisting of cobalt (Co), nickel (Ni), lithium (Li), boron (B), sodium (Na), potassium (K), and silicon (Si); and a glass containing one or more elements selected from the group consisting of cobalt, nickel, lithium, boron, sodium, potassium, and silicon.

### Thickness of Dielectric Layer

The thickness of each dielectric layer 11 is preferably, but not necessarily, for example, 1.0 μm or less, more preferably 0.8 μm or less, from the viewpoint of enabling an increase in the laminated number of layers to increase the capacitance while reducing the size of the multilayer ceramic capacitor 100.

The lower limit of the thickness of each of the dielectric layers 11 can be, but is not particularly limited to, two or more or four or more times the average diameter of the dielectric material particles used, from the viewpoint of improving productivity and yield. For example, when the average diameter of the particles of the dielectric material used is 0.1 μm, the lower limit of the thickness of each dielectric layer 11 can be 0.2 μm or more or 0.4 μm or more.

The thickness of each of the dielectric layers 11 is evaluated on a cross-section including the first axis parallel to the lamination direction. For ease of polishing and measurement, it is preferable to evaluate the thickness at either a cross-section that further includes the second axis perpendicular to the lamination direction, or a cross-section that further includes the third axis perpendicular to the lamination direction and also perpendicular to the second axis. For the former, the ceramic capacitor 100 is polished in the direction of the third axis. For the latter, the ceramic capacitor 100 is polished in the direction of the second axis. The thickness of each of the five layers (when the number of layers of the dielectric layers 11 is an even number, six layers may be used at the center) located in each of the center, the upper end, and the lower end of the exposed dielectric layers 11 in the direction of the first axis is measured at three locations: the middle portion, the left side, and the right side of each layer. These measurements are used to define the thickness of each dielectric layer 11. The average of all measurements can be defined as the thickness of each dielectric layer 11.

In the example illustrated in FIGS. 1 and 2, the first axis, which is the lamination direction, is the Z-axis direction. Thus, this is an example in which the multilayer ceramic capacitor 100 is polished along the Y-axis, which is the third axis, to expose the XZ plane on which the internal electrode layers 12 and the dielectric layers 11 are laminated. On the exposed XZ plane, five layers (when the number of the dielectric layers 11 is an even number, six layers may be used) of the dielectric layers 11 located in the center along the first axis, which is the Z-axis, and five layers of the dielectric layers 11 located in each of the upper end and the lower end along the first axis, which is the Z-axis, are selected. At this time, the dielectric layers 11 are selected from within the capacitive part 14.

Then, for each of the selected dielectric layers 11, the thickness is measured at three locations along the X-axis, which is the second axis, namely, ¼, ½, and ¾ of the length of the X-axis, and the average value of the measurements is defined as the thickness of each dielectric layer 11. Using the same procedure, the thicknesses of all the selected dielectric layers 11 are measured, and the average value of the measurements can be defined as the thickness of each dielectric layer 11 in the evaluated multilayer ceramic capacitor 100.

For each of the dielectric layers 11, the thickness is measured at the center along the X-axis, which is the second axis, and the measured value is used as the thickness of the dielectric layer 11. Using the same procedure, the thicknesses of all the selected dielectric layers 11 are measured, and the average value of the measurements is calculated. The resulting average value can be defined as the thickness of each dielectric layers 11 in the multilayer ceramic capacitor 100.

### Intermediate Region

Each of the intermediate regions 40 contains nickel and copper, and the composition thereof is not particularly limited. In a line analysis using TEM-EDS analysis, regions where the metal concentration A (at %) of nickel is 3 at %<A<50 at % are defined as the intermediate regions 40.

To ensure that the intermediate regions 40 are superior in denseness to the surrounding dielectric layers, the average metal concentration D40 (at %) of copper in the intermediate regions 40 is preferably 0.05 at %≤D40 (at %)≤15 at %, and D11<D40, where D11 is the average metal concentration (at %) of copper in the dielectric layers 11. When D11 is equal to or larger than D40, the capacitance of the multilayer ceramic capacitor 100 may decrease significantly.

The average metal concentration D40 of copper in the intermediate regions 40 can be determined as described below.

In the example illustrated in FIGS. 1 and 2, the first axis, which is the lamination direction, is the Z-axis direction. Thus, this is an example in which the multilayer ceramic capacitor 100 is polished along a direction perpendicular to the Y-axis, which is the third axis, to expose the XZ plane on which the internal electrode layers 12 and the dielectric layers 11 are laminated. On the exposed XZ plane, the set of the internal electrode layers 12 and the dielectric layers 11 located at the third to tenth layers counted from the end of the upper face along the Z-axis, which is the first axis, a set of a total of 10 layers of the internal electrode layers 12 and the dielectric layers 11 located in the center, and the set of the internal electrode layers 12 and the dielectric layers 11 located at the third to tenth layers counted from the end of the lower face are selected.

In each of the set of the internal electrode layers 12 and the dielectric layers 11 located at the third to tenth layers counted from the end of the upper face along the Z-axis, which is the first axis, the set of a total of 10 layers of the internal electrode layers 12 and the dielectric layers 11 located in the center, and the set of the internal electrode layers 12 and the dielectric layers 11 located at the third to tenth layers counted from the end of the lower face, three measurement portions are properly or randomly selected within a range of 70% from the center along the X-axis toward the side edges, which is the second axis, in such a manner that the center-to-center distance between the nearest measurement portions is 30 to 100 μm. Then, line analysis is performed using TEM-EDS along the Z-axis at each measurement portion to measure the metal concentrations (at %) of nickel (Ni) and copper (Cu) on the line. It should be noted that each measurement portion is selected from within the capacitive part 14. The size of each measurement portion is 1.0 to 3.0 μm square.

In this case, the measurement portions in the set of the internal electrode layers 12 and the dielectric layers 11 located at the third to tenth layers counted from the end of the upper face are designated as measurement portions 1 to 3. The measurement portions in the set of a total of 10 layers of the internal electrode layers 12 and the dielectric layers 11 located in the center are designated as measurement portions 4 to 6. The measurement portions in the set of the internal electrode layers 12 and the dielectric layers 11 located at the third to tenth layers counted from the end of the lower face are designated as measurement portions 7 to 9. The above operation is performed in the measurement portions 1 to 9, and the metal concentrations (at %) of nickel (Ni) and copper (Cu) on the line are measured in each measurement portion.

With regard to each intermediate region 40 where an metal concentration A (at %) of nickel of 3 at % to 50 at % can be observed in each measurement portion, the metal concentrations of copper in the intermediate region 40 are measured at evenly spaced intervals in a range of 70% from the center of the intermediate region 40 toward the top/bottom edges in the direction along the Z-axis, which is the first axis, and the measured values are averaged. The resulting average value is defined as the average metal concentration of copper in the intermediate region 40 in the measurement portion. The average value of the metal concentrations of copper in the intermediate regions 40 in all the measurement portions (measurement portions 1 to 9) is defined as the average metal concentration D40 (at %) of copper in the intermediate regions 40 in the multilayer ceramic capacitor 100.

In the multilayer ceramic capacitor that includes the laminate body including the plurality of dielectric layers laminated along the first axis, the plurality of internal electrode layers each disposed between adjacent dielectric layers of the plurality of dielectric layers along the first axis, and the intermediate regions each disposed between each of the plurality of dielectric layers and a corresponding one of the plurality of internal electrode layers, an average metal concentration D40E (at %) of copper in the intermediate regions disposed in a set of the plurality of internal electrode layers and the plurality of dielectric layers located at the third to tenth layers counted from the end of the upper face of the laminate body in the lamination direction and in the intermediate regions disposed in the set of the plurality of internal electrode layers and the plurality of dielectric layers located at the third to tenth layers counted from the end of the lower face is higher than the average metal concentration D40M (at %) of copper in the intermediate regions disposed in the set of a total of 10 layers of the plurality of internal electrode layers and the plurality of dielectric layers located in the center of the laminate body in the lamination direction.

When D40E (at %) is higher than D40M (at %), the rigidity of the internal electrode layers adjacent to the upper and lower faces of the multilayer ceramic capacitor is higher than the rigidity of the internal electrode layers located at the center of the multilayer ceramic capacitor. Consequently, the displacement generated by the electrostrictive effect is mechanically compressed from above and below, thereby inhibiting a reduction in capacitance due to cracking and the occurrence of acoustic noise.

With regard to the average metal concentration D40E of copper in the intermediate regions 40, the average value of the metal concentrations of copper in the intermediate regions 40 in the above-described measurement portions 1 to 3 and 7 to 9 is defined as the average metal concentration D40E (at %) of copper in the intermediate regions 40 in the multilayer ceramic capacitor 100.

With regard to the average metal concentration D40M of copper in the intermediate region 40, the average value of the metal concentrations of copper in the intermediate regions 40 in the above-described measurement portions 4 to 6 is defined as the average metal concentration D40M (at %) of copper in the intermediate regions 40 in the multilayer ceramic capacitor 100.

In the multilayer ceramic capacitor, the average metal concentration (at %) of copper in each of the intermediate regions preferably varies in the lamination direction of the laminate body including the plurality of dielectric layers laminated along the first axis, the plurality of internal electrode layers each disposed between adjacent dielectric layers of the plurality of dielectric layers along the first axis, and the intermediate regions each disposed between each of the plurality of dielectric layers and a corresponding one of the plurality of internal electrode layers, and may vary linearly, curvilinearly, or intermittently in the lamination direction of the laminate body.

When the average metal concentration (at %) of copper in each of the intermediate regions changes in the lamination direction of the laminate body, the strain levels in the internal electrode layers in the non-strained portions and the dielectric layers that generate strain upon the application of an electric field can be connected stepwise to relieve local stress due to the strain. In this way, the intermediate regions also function as stress-relieving layers, which is preferred because it inhibits the occurrence of cracking. More preferably, the average metal concentration (at %) of copper in each of the intermediate regions varies continuously, linearly or curvilinearly, in the lamination direction of the laminate body in such a manner that the stress is continuously and gradually relieved in the lamination direction of the laminate body.

FIG. 4 is a cross-sectional view illustrating details of an element body according to an embodiment of the present disclosure.

FIG. 4 is a partially enlarged view of the internal electrode layers 12 and the dielectric layers 11 in the element body 10. FIG. 4 is an enlarged view of region D in FIG. 3, for example.

In the multilayer ceramic capacitor 100, each of the intermediate regions 40 containing nickel and copper is disposed between each of the dielectric layers 11 and a corresponding one of the internal electrode layers 12. Since FIG. 4 is a schematic view, each intermediate region 40 is illustrated as a continuous layer having a constant thickness, but is not limited to this form. Each intermediate region 40, for example, may be discontinuous, may be a discontinuous layer, and may vary in thickness from place to place. It should be noted that each intermediate region 40 disposed near the boundary between each of the internal electrode layers 12 and a corresponding one of the dielectric layers 11 can be regarded as an intermediate region of a single layer, whether it is continuous or discontinuous.

It is sufficient that each intermediate region 40 contains nickel and copper and the metal concentration A (at %) of nickel is 3 at %<A<50 at %. The state of nickel and copper in the intermediate regions 40 is not particularly limited. In the intermediate regions 40, nickel and copper may form a compound, and nickel and copper may each form a compound with another element or the like. In the intermediate regions 40, at least one of nickel and copper may be present in an elemental state without forming a compound.

### Method for Manufacturing Multilayer Ceramic Capacitor

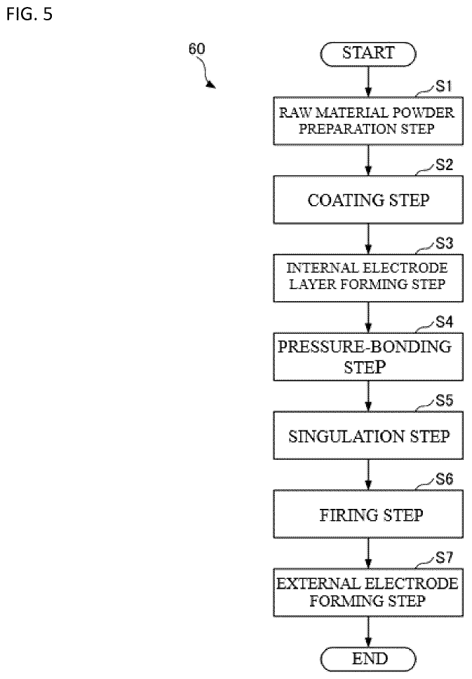

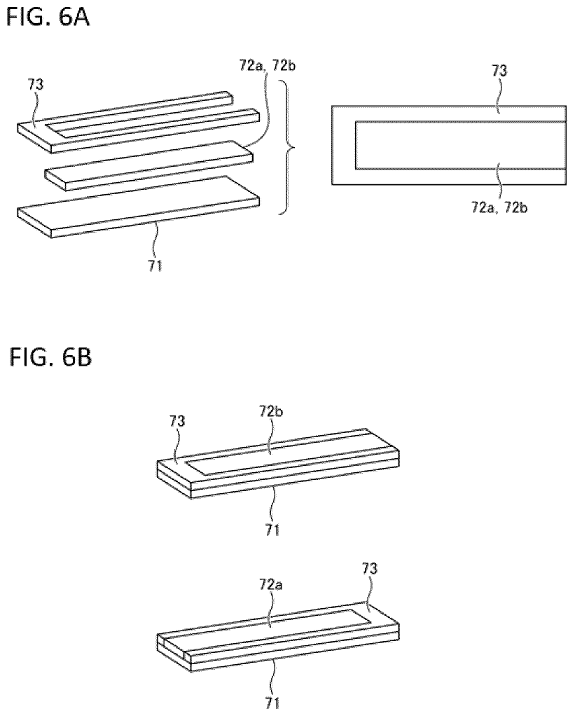

Next, a method for manufacturing the multilayer ceramic capacitor 100 will be described below. FIG. 5 is a flowchart 60 illustrating an example of a method for manufacturing the multilayer ceramic capacitor 100. FIGS. 6A and 6B illustrate an example of a method for manufacturing the multilayer ceramic capacitor 100.

### (1) Raw Material Powder Preparation Step (S1)

In a raw material powder preparation step, a dielectric material containing barium titanate and copper is prepared for the formation of the dielectric layers 11. Barium titanate can typically be prepared by reacting a titanium material, such as titanium dioxide, with a barium material, such as barium carbonate. As a method for synthesizing a ceramic material that is the main component of the dielectric layers 11, various methods have been conventionally known, such as a solid-phase method, a sol-gel method, and a hydrothermal method. In the present embodiment, any of these can be adopted.

In the raw material powder preparation step, copper or a compound containing copper is added as an additive to the resulting ceramic raw material powder. Examples of the compound containing copper include copper oxide and copper carbonate. The resulting ceramic raw material powder may further contain a predetermined additive compound in accordance with the purpose. Examples of the additive compound include oxides containing one or more elements selected from the group consisting of zirconium (Zr), magnesium (Mg), molybdenum (Mo), manganese (Mn), vanadium (V), chromium (Cr), rare-earth elements, such as scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb); oxides containing one or more elements selected from the group consisting of cobalt (Co), nickel (Ni), lithium (Li), boron (B), sodium (Na), potassium (K), and silicon (Si); and a glass containing one or more elements selected from the group consisting of cobalt, nickel, lithium, boron, sodium, potassium, and silicon.

For example, a ceramic material can be prepared by wet-mixing a ceramic raw material powder with an additive containing copper or a compound containing an additive compound, followed by drying and pulverization. For example, the ceramic material obtained as described above may be subjected to pulverization treatment as necessary to adjust the particle size, or may be combined with a classification treatment to adjust the particle diameter. A dielectric material is prepared by the above step.

### (2) Coating Step (S2)

Next, in a coating step, a binder, such as a polyvinyl butyral (PVB) resin, an organic solvent, such as ethanol or toluene, and a plasticizer can be added to the resulting raw material powder. The mixture can be wet-mixed. It should be noted that in the raw material powder preparation step (S1), when the ceramic raw material powder and other materials are mixed, a binder and the like may be added, and the mixture may be wet-mixed.

In the coating step, ceramic green sheets 71 containing the prepared ceramic raw material powder can be formed on a substrate by a method, such as a die coating or doctor blade method, using the resulting slurry, and then dried. The substrate is, for example, a polyethylene terephthalate (PET) film. A figure illustrating the coating step is omitted. The ceramic green sheets 71 are each an example of a dielectric green sheet.

### (3) Internal Electrode Layer Forming Step (S3)

The first internal electrode layers 12a and the second internal electrode layers 12b each contain nickel (Ni) and copper (Cu), and may further contain a base metal, such as tin (Sn), or an alloy containing this. The internal electrode layers 12 may contain a noble metal, such as platinum (Pt), palladium (Pd), silver (Ag), or gold (Au), or an alloy containing them.

The main component of the first internal electrode layers 12a and the main component of the second internal electrode layers 12b may be the same or different. As an example, the main component of both the first internal electrode layer 12a and the second internal electrode layer 12b may be the same, that is, nickel.

A conductive metal paste, which is an internal electrode layer slurry for forming a precursor of the first internal electrode layers 12a and the second internal electrode layers 12b, can be prepared by kneading the main component selected from the above components, nickel, copper, an organic binder, and a solvent. Copper may be added in the form of an elemental form or in the form of a compound containing copper. Examples of the compound containing copper include copper oxide and copper carbonate.

In the formation of the internal electrode layers, as illustrated in FIG. 6A, a conductive metal paste containing an organic binder for forming the internal electrode layers can be applied to a surface of the ceramic green sheet 71 by, for example, screen printing or gravure printing. Thereby, a first internal electrode layer pattern 72a for the first internal electrode layers 12a or a second internal electrode layer pattern 72b for the second internal electrode layers 12b is arranged on the surface of the ceramic green sheet 71. Ceramic grains may also be added to the conductive metal paste as a co-existent material. The main component of the ceramic grains is not particularly limited, but is preferably identical to a ceramic material serving as the main component of the dielectric layers 11. In the case of adding the ceramic grains as a co-existent material, the ceramic grains can be added when the conductive metal paste is kneaded. A method for forming the internal electrode layers is not limited to application by printing, but plating, vacuum deposition, sputtering, or CVD may also be used.

A binder, such as an ethyl cellulose-based binder, and an organic solvent, such as a terpineol-based binder, can be added to a dielectric pattern material prepared in the raw material powder preparation step, and the mixture can be kneaded in a roll mill to prepare a dielectric pattern paste for a reverse pattern layer. As illustrated in FIG. 6A, the dielectric pattern paste may be applied by printing to the peripheral area where the internal electrode layer pattern is not printed on the ceramic green sheet 71 to arrange the dielectric pattern 73, thereby eliminating the step difference with the internal electrode layer pattern. The ceramic green sheet 71 on which the internal electrode layer pattern and the dielectric pattern 73 are formed by printing is referred to as a “lamination unit”.

As illustrated in FIG. 6B, the lamination units can be laminated in such a manner that the internal electrode layers and the dielectric layers are alternately laminated and that the end edges of the internal electrode layers are alternately exposed to both end faces in the longitudinal direction of the dielectric layers so as to be extracted to a pair of external electrodes (laminating step). Specifically, ceramic green sheets 71 each including the first internal electrode layer pattern 72a and the dielectric pattern 73 arranged by printing and ceramic green sheets 71 each including the second internal electrode layer pattern 72b and the dielectric pattern 73 arranged by printing are laminated in order in such a manner that each of the internal electrode layers is interposed between the ceramic green sheets 71. For example, the number of lamination units laminated may be 100 to 500.

### (4) Pressure-Bonding Step (S4)

In a pressure bonding-step, a predetermined number of cover sheets, for example, 2 to 10 layers, can be laminated on the upper and lower faces of the laminated body including the lamination units. Then the laminated body can be subjected to thermocompression bonding to form a pressure-bonded body.

### (5) Singulation Step (S5)

In a singulation step, the pressure-bonded body can be singulated into pieces. A known singulation method, such as dicing with a dicer or laser cutting, may be adopted as appropriate.

### (6) Firing Step (S6)

In a firing step, the singulated laminated body pieces can be fired. The firing conditions are not particularly limited, but for example, firing can be performed in a reducing atmosphere with an oxygen partial pressure of 10⁻¹² atm or more and 10⁻⁸ atm or less, a rate of temperature increase of 5,000° C./h or more, and a temperature of 1,100° C. or higher and 1,350° C. or lower, for 5 minutes to 10 hours. Preferably, the temperature is 1,150° C. or higher and 1,350° C. or lower. At a temperature of 600° C. or higher, the rate of temperature increase is preferably adjusted to 10,000° C./h or higher in order to control the diffusion of copper contained in the internal electrode layer slurry.

To strongly inhibit the copper contained in the internal electrode layer slurry from diffusing more than necessary toward the dielectric layers, the rate of temperature increase from 600° C. to 1,300° C. is more preferably 30,000° C./h or higher (the upper-limit value of rate of rise in temperature is not specifically limited, but preferably it is set to 50000° C./h or lower). The oxygen partial pressure in the temperature range is more preferably 10-12 atm or more and 10⁻¹¹ atm or less. The holding time at the maximum temperature in the firing step is more preferably 10 seconds or less. To inhibit the change of atmosphere and cracking due to gases generated from residues caused by degreasing process at elevated temperatures, preferably, the amount of green laminated body pieces fed is reduced to ½ of the normal amount, and even if the amount of gases generated increases, the firing atmosphere is adjusted by the oxygen partial pressure as appropriate.

### (7) External Electrode-Forming Step (S7)

In an external electrode-forming step, the first external electrode 20a and the second external electrode 20b can be formed by, for example, plating treatment. Through the above steps, the multilayer ceramic capacitor 100 is completed.

The above steps are merely an example, and the method for manufacturing the multilayer ceramic capacitor according to the present embodiment is not limited to the above embodiment.

### Other Embodiments

Although embodiments have been described in detail above, the present disclosure is not limited to the specific embodiments, and various modifications and changes can be made within the scope described in the claims.

For example, the above embodiment is applied to a multilayer ceramic capacitor having two terminal electrodes, but may be applied to a multilayer ceramic capacitor having three or more terminals.

Furthermore, in the above embodiment, a multilayer ceramic capacitor has been described as an example of a multilayer ceramic electronic component, but the present disclosure is applicable to multilayer ceramic electronic components in general. Examples of such multilayer ceramic electronic components include chip varistors and chip thermistors.

### EXAMPLES

The present invention will be described below with reference to specific examples, but is not limited to these examples.

### (1) Manufacture of Multilayer Ceramic Capacitor

### Example 1

FIG. 5 is a flowchart of a method for manufacturing a multilayer ceramic capacitor according to an embodiment of the present disclosure.

A multilayer ceramic capacitor was manufactured according to the flowchart 60 described in FIG. 5.

Specifically, a barium titanate powder, a polyvinyl butyral (PVB) resin, a solvent, a plasticizer, and a glass powder containing SiO₂ as a sintering auxiliary agent were wet-mixed to prepare a slurry (raw material powder preparation step).

The resulting slurry was applied onto a substrate film, and the slurry applied onto the substrate film was dried to form ceramic green sheets (coating step).

Next, an organometallic complex solution and a fine powder containing copper were added to a Ni powder, which is the main metal element, in such a manner that the metal concentration in the multilayer ceramic capacitor was 5 at %, and the mixture was mixed to prepare a mixed powder. A polyvinyl butyral (PVB) resin, a solvent, and a plasticizer were added to the prepared mixed powder, and the mixture was wet-mixed to prepare an internal electrode layer slurry. The internal electrode layer slurry was applied by printing onto a partial area of a surface of each of the ceramic green sheets to form an internal electrode layer pattern on each ceramic green sheet, thereby forming a lamination unit (internal electrode layer forming step). This lamination unit includes the ceramic green sheet and the internal electrode layer pattern arranged on the surface of the ceramic green sheet.

Next, 470 lamination units were laminated to form a laminated body. The laminated body was pressure-bonded and then singulated to provide chip-shaped green laminate bodies (pressure-bonding step and singulation step).

Then, the chip-shaped green laminated bodies were subjected to degreasing process in a nitrogen atmosphere. The chip-shaped green laminate bodies after the degreasing process were placed in a firing furnace and fired for 20 minutes in a reducing atmosphere at 1,300° C. with the oxygen partial pressure kept in a range of 10⁻¹² atm to 10⁻¹¹ atm (firing step).

To strongly inhibit the copper contained in the internal electrode layer slurry from diffusing more than necessary toward the dielectric layers, the rate of temperature increase from 600° C. to 1,300° C. was 30,000° C./h, the oxygen partial pressure in the temperature range was kept at 1×10⁻¹² atm or more and 5×10⁻¹² atm or less, and the holding time at the maximum temperature in the firing was 10 seconds. To inhibit the change of atmosphere and cracking due to gases generated from residues caused by degreasing process at elevated temperatures, the amount of chip-shaped green laminated bodies fed was reduced to ½ of the normal amount, and even if the amount of gases generated increases, the firing atmosphere was adjusted by adjusting the oxygen partial pressure as appropriate.

Each of the fired laminate bodies was subjected to plating treatment to form the first external electrode 20a and the second external electrode 20b (external electrode-forming step).

Each of the resulting multilayer ceramic capacitors had a chip size of 1.0 mm×0.5 mm×0.5 mm, a thickness T1 of each internal electrode layer 12 of 0.4 μm, and a thickness T2 of each dielectric layer 11 of 0.8 μm, and the number of layers laminated was 470. The thicknesses of the internal electrode layers 12 and the dielectric layers 11 were evaluated by the procedure already described.

The resulting multilayer ceramic capacitors were evaluated as described below. The evaluation results are presented in Table 1.

### (2) Evaluation Method

### (2-1) Identification of Intermediate Region and Measurement of Average Metal Concentrations D12 to D40E (at %)

When regions near the boundaries between the internal electrode layers and the dielectric layers were observed, since the first axis, which was the lamination direction, was the Z-axis direction in the example illustrated in FIGS. 1 and 2, the multilayer ceramic capacitor 100 was polished along the Y-axis, which was the third axis, to expose the XZ plane where the internal electrode layers 12 and the dielectric layers 11 were laminated. On the exposed XZ plane, a set of the internal electrode layers 12 and the dielectric layers 11 located at the third to tenth layers counted from the end of the upper face along the Z-axis, which was the first axis, a set of a total of 10 layers of the internal electrode layers 12 and the dielectric layers 11 located in the center, and a set of the internal electrode layers 12 and the dielectric layers 11 located at the third to tenth layers counted from the end of the lower face were selected. The selected sets of the internal electrode layers 12 and the dielectric layers 11 were observed by a TEM.

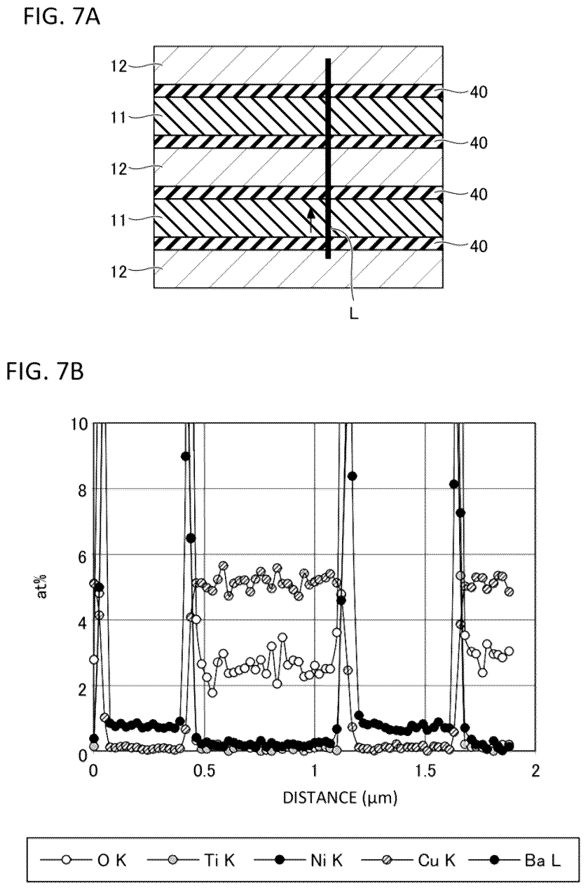

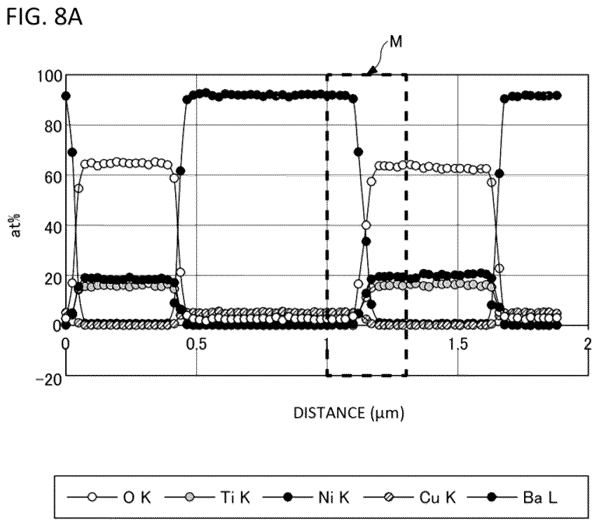

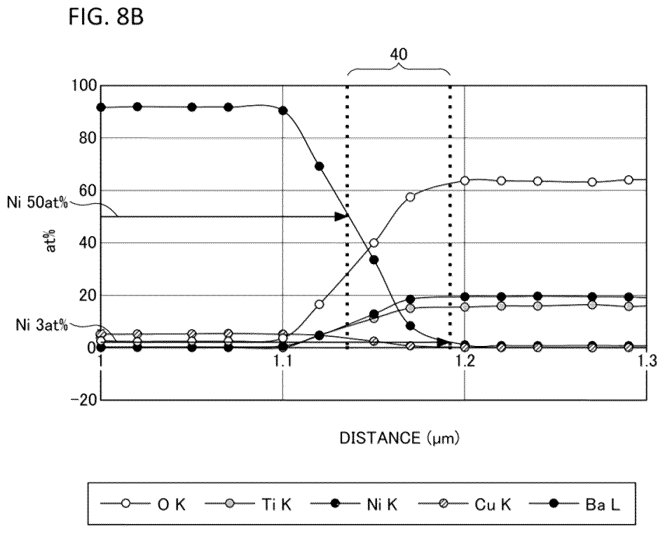

In each of the set of the internal electrode layers 12 and the dielectric layers 11 located at the third to tenth layers counted from the end of the upper face along the Z-axis, which was the first axis, the set of a total of 10 layers of the internal electrode layers 12 and the dielectric layers 11 located at the center, and the set of the internal electrode layers 12 and the dielectric layers 11 located at the third to tenth layers counted from the end of the lower face, three measurement portions are freely selected within a range of 70% from the center along the X-axis, which is the second axis, in such a manner that the center-to-center distance between the nearest measurement portions was 30 to 100 μm. In one measurement portion, a line L on a schematic partial cross-sectional view of a multilayer ceramic capacitor illustrated in FIG. 7A was analyzed in the direction of the arrow using TEM-EDS, and the metal concentrations (at %) of barium (Ba), titanium (Ti), oxygen (O), nickel (Ni), and copper (Cu) on the line were measured (FIG. 7B and FIGS. 8A and 8B). It should be noted that each measurement portion was selected from within the capacitive part 14. The size of each measurement portion was 2 μm square.

The measurement portions in the set of the internal electrode layers 12 and the dielectric layers 11 located at the third to tenth layers counted from the end of the upper face were designated as measurement portions 1 to 3. The measurement portions in the set of a total of 10 layers of the internal electrode layers 12 and the dielectric layers 11 located in the center were designated as measurement portions 4 to 6. The measurement portions in the set of the internal electrode layers 12 and the dielectric layers 11 located at the third to tenth layers counted from the end of the lower face were designated as measurement portions 7 to 9. The above operation was performed in measurement portions 1 to 9, and the metal concentrations (at %) of barium (Ba), titanium (Ti), oxygen (O), nickel (Ni), and copper (Cu) on the line were measured in each measurement portion.

In a region near the boundary between the internal electrode layer 12 and the dielectric layer 11 where the distribution of nickel and copper was observed in each of the measurement portions 1 to 9, a region where the metal concentration A (at %) of nickel was 3 at %<A<50 at % was defined as the intermediate region 40 in each measurement portion (FIG. 8B).

In each of the measurement portions 1 to 9, for each internal electrode layer 12 whose cross-section could be observed in its entirety, the metal concentrations of copper in the internal electrode layer 12 were measured at intervals of 25 nm in a range of 70% from the center of the internal electrode layer 12 in the direction along the Z-axis, which was the first axis, and the measured values were averaged. The resulting average value was defined as the average metal concentration of copper in the internal electrode layers 12 in the measurement portion. The average value of the metal concentrations of copper in the internal electrode layers 12 at all the measurement portions (measurement portions 1 to 9) was defined as the average metal concentration D12 (at %) of copper in the internal electrode layers 12 in the multilayer ceramic capacitor 100.

In each of the measurement portions 1 to 9, for each the dielectric layer 11 whose cross-section could be observed in its entirety, the metal concentrations of copper in the dielectric layer 11 were measured at intervals of 25 nm in a range of 70% from the center of the dielectric layer 11 in the direction along the Z-axis, which was the first axis, and the measured values were averaged. The average value of the metal concentrations of copper in the dielectric layers 11 in all the measurement portions (measurement portions 1 to 9) was defined as the average metal concentration D11 (at %) of copper in the dielectric layers 11 in the multilayer ceramic capacitor 100.

With regard to each intermediate region 40 where an metal concentration A (at %) of nickel of 3 at % to 50 at % could be observed in each of the measurement portions 1 to 9, the metal concentrations of copper in the intermediate region 40 were measured at intervals of 25 nm in a range of 70% from the center of the intermediate region 40 in the direction along the Z-axis, which was the first axis, and the measured values were averaged. The resulting average value was defined as the average metal concentration of copper in the intermediate regions 40 in the measurement portion. The average value of the metal concentrations of copper in the intermediate regions 40 in all the measurement portions (measurement portions 1 to 9) was defined as the average metal concentration D40 (at %) of copper in the intermediate regions 40 in the multilayer ceramic capacitor 100.

The average value of the metal concentrations of copper in the intermediate regions 40 in the measurement portions (measurement portions 1 to 3 and 7 to 9) was defined as the average metal concentration D40E (at %) of copper in the intermediate regions 40 in the multilayer ceramic capacitor 100.

### (2-2) Capacitance Measurement

The capacitances of the produced multilayer ceramic capacitors were measured.

A method used in the present disclosure for measuring the capacitance of a multilayer ceramic capacitor will be described below. The capacitances of 200 freely-selected multilayer ceramic capacitors were measured, and the average value of the measurements was used as a representative value for comparison. The measurement conditions were as follows: Both terminals of each multilayer ceramic capacitor were sandwiched using Test Fixture 16034E, and measurement was performed with an LCR meter. At this time, an AC voltage source with a frequency of 120 Hz and an amplitude of 0.5 Vrms was connected. The AC voltage application time was 10 seconds. The temperature of the measurement environment was in the range of 25° C.±3° C.

The capacitance of the multilayer ceramic capacitor was measured by the above method.

It should be noted that in this example, the measurement frequency was set to 120 Hz, but the present disclosure is not limited thereto, and it is needless to say that the present disclosure can be applied to other frequencies.

### (2-3) Measurement of Acoustic Noise

The produced multilayer ceramic capacitors were evaluated for acoustic noise.

A predetermined number of 0.8-mm-thick epoxy resin substrates on which copper conductor pads had been formed were provided. The produced multilayer ceramic capacitors were mounted on the substrates with solder in such a manner that the applied thickness was 0.05 mm to produce evaluation samples. A total of 200 evaluation samples were produced. An AC voltage of 5 V at 1 KHz was applied to the conductor pads of each evaluation sample for 5 seconds. The sound level of the generated sound was measured 10 cm above the evaluation sample in a soundproof and anechoic room. The number of evaluation samples in which the sound level of the generated sound exceeded 20 dB was counted.

### (2-4) Magnetic Transportability

A total of 1,000 samples, which had been produced up to the firing step and before the formation of the external electrodes, were transported horizontally for 1.5 m by adsorbing their upper faces onto the transport surface of a transport magnet, the transport surface being coated with a 1-mm-thick resin. Nickel-copper alloys become non-magnetic when the copper ratio exceeds a certain concentration (at %), making them less likely to be attracted to a magnet. When the sample was attracted to the magnet and did not fall off until the end of the transfer, the magnet transportability was rated as “A”. When there was even one failure to attract the sample or when the sample fell off before the end of the transfer, the magnet transportability was rated as “B”.

### Examples 2 to 5 and Comparative Examples 1 and 2

The multilayer ceramic capacitors in Examples 2 to 5 and Comparative Examples 1 and 2 were manufactured in the same manner as in Example 1, except that the amount of copper added to the raw materials of the internal electrode layers 12 and the dielectric layers 11 was changed in such a manner that the average metal concentrations of copper in the internal electrode layers and the dielectric layers had the numerical values and relationships given in Table 1.

The multilayer ceramic capacitors in Examples 2 to 5 and Comparative Examples 1 and 2 were also evaluated as described above.

A multilayer ceramic capacitor in which no acoustic noise occurred in all the evaluation samples and the relative value of the capacitance of each multilayer ceramic capacitor was 85 or more when the capacitance of the multilayer ceramic capacitor of Comparative Example 1 was set to 100 was determined to be a multilayer ceramic capacitor in which acoustic noise was inhibited while maintaining high capacitance.

TABLE 1

| | | | | | | Number of | | |
|---|---|---|---|---|---|---|---|---|
| | | | | | | samples where | Relative | |
| | | | | | | acoustic noise | capacitance when | |
| | | | Concentration | Concentration | | occurred/number | capacitance in | |
| | | | relationship | relationship | | of samples | Comparative | |
| | D11 | D12 | between D11 | between D40M | | tested for | Example 1 | Magnetic |
| | (at %) | (at %) | and D40 | and D40E | T1/T2 | acoustic noise | is 100 | transportability |
| Example 1 | 0.1 | 5 | D11 < D40 | D40M < D40E | 1.8 | 0/200 | 98 | A |
| Example 2 | 0.1 | 10 | D11 < D40 | D40M < D40E | 1.9 | 0/200 | 103 | A |
| Example 3 | 0.1 | 1 | D11 < D40 | D40M < D40E | 1.8 | 0/200 | 105 | A |
| Example 4 | 1 | 30 | D11 < D40 | D40M < D40E | 2.1 | 0/200 | 92 | A |
| Example 5 | 1 | 35 | D11 < D40 | D40M < D40E | 2.1 | 0/200 | 93 | B |
| Comparative | <0.01 | 0.1 | D11 < D40 | D40M < D40E | 1.8 | 3/200 | 100 | A |
| Example 1 | | | | | | | | |
| Comparative | 5 | 1 | D11 > D40 | D40M < D40E | 1.9 | 0/200 | 83 | A |
| Example 2 | | | | | | | | |

The results presented in Table 1 indicated that in Examples 1 to 5, when the capacitance of the multilayer ceramic capacitor of Comparative Example 1 was set to 100, the relative capacitance of each multilayer ceramic capacitor was 85 or more, and no acoustic noise occurred.

In Comparative Example 1, acoustic noise occurred in three evaluation samples.

In Comparative Example 2, when the capacitance of the multilayer ceramic capacitor of Comparative Example 1 was set to 100, the relative capacitance value of each multilayer ceramic capacitor was less than 85.

From the above, it has been demonstrated that a multilayer ceramic electronic component conforming to the configurations disclosed in the present disclosure is a multilayer ceramic electronic component in which, surprisingly, acoustic noise is inhibited while maintaining a high electrostatic capacitance.

For example, some embodiments are described below.
<1> A multilayer ceramic electronic component includes:
   a laminate body including:
      a plurality of dielectric layers laminated along a first axis,
      a plurality of internal electrode layers each disposed between adjacent dielectric layers of the plurality of dielectric layers along the first axis, and
      intermediate regions each disposed between each of the plurality of dielectric layers and a corresponding one of the plurality of internal electrode layers,
   in which each of the plurality of dielectric layers contains barium titanate and copper,
   the plurality of internal electrode layers and the intermediate regions each contain nickel and copper,
   the metal concentration A (at %) of nickel in each of the intermediate regions is 3 at %<A<50 at % whereas a metal concentration B (at %) of nickel in each of the internal electrode layer is A<B,
   in which the following relationships are satisfied:

$$D 12 > D 11 , and D 11 < D 40$$

where D12 (at %) is the average metal concentration of copper in the plurality of internal electrode layers, D11 (at %) is the average metal concentration of copper in the plurality of dielectric layers, and D40 (at %) is the average metal concentration of copper in the intermediate regions, and

$$D 12 is 0.1 at \% < D 12 \leq 35 at \% , and D 11 is 0.01 at \% < D 11 < 5 at \% .$$

<2> In the multilayer ceramic electronic component described in <1>, the average metal concentration D40E (at %) of copper in the intermediate regions disposed in a set of the plurality of internal electrode layers and the plurality of dielectric layers located at the third to tenth layers counted from an end of an upper face of the laminate body in the lamination direction and in the intermediate regions disposed in a set of the plurality of internal electrode layers and the plurality of dielectric layers located at the third to tenth layers counted from an end of a lower face is higher than an average metal concentration D40M (at %) of copper in the intermediate regions disposed in a set of a total of 10 layers of the plurality of internal electrode layers and the plurality of dielectric layers located in the center of the laminate body in the lamination direction.
<3> In the multilayer ceramic electronic component described in <1> or <2>, the average metal concentration (at %) of copper in each of the intermediate regions varies in the lamination direction of the laminate body.
<4> In the multilayer ceramic electronic component described in any one of <1> to <3>, D40 (at %) is 0.05 at %≤D40≤15 at %.
<5> A method for manufacturing a multilayer ceramic electronic component includes:
   a raw material powder preparation step of preparing a ceramic raw material powder for forming a dielectric layer, the ceramic raw material powder containing barium titanate and copper;
   a coating step of applying a slurry containing the ceramic raw material powder onto a substrate to form ceramic green sheets;
   an internal electrode layer-forming step of applying an internal electrode layer slurry containing nickel and copper onto a surface of each of the ceramic green sheets by printing to form an internal electrode layer;
   a pressure-bonding step of pressure-bonding a laminated body in which the ceramic green sheets each including the internal electrode layer are laminated and the internal electrode layer is interposed between the ceramic green sheets, to form a pressure-bonded laminated body;
   a singulation step of singulating the pressure-bonded laminated body into laminated body pieces; and
   a firing step of firing the singulated laminated body pieces,
   in which in the firing step, a rate of temperature rise from 600° C. to 1,300° C. is 30,000° C./h or higher.

According to the multilayer ceramic electronic components described in any one of <1> to <4> and the method for manufacturing the multilayer ceramic electronic component described in <5>, the known or potential problems in the related art can be solved and the objects of the present disclosure can be achieved.

In this disclosure, in some embodiments, the material/composition constituting dielectric layers, internal electrode layers, and intermediate regions may consist of required/explicitly indicated elements described in the present disclosure; however, “consisting of” does not exclude additional components that are known equivalents to the elements and/or unrelated components such as impurities ordinarily associated with the elements. Also, in some embodiments, the term “main component” refers to “primary, majority, or predominant component in terms of quantity or quality, and the term “mainly composed of” refers to “primarily, mostly, or predominantly composed of” in terms of quantity or quality. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”), such as the content of the additive element and the content of copper, may refer to precise values or approximate/rounded values and include equivalents, and may refer to average, median, representative, majority, etc. in some embodiments. In this disclosure, “a” may refer to a species or a genus including multiple species, while a plural may not exclude singular according to the context. Further, “the invention/disclosure” or “the present invention/disclosure” may refer collectively to at least one of the embodiments or examples explicitly or inherently disclosed herein. Also, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc. Additionally, in the present invention/disclosure where conditions and/or structures are not specified, a skilled artisan in the art can readily provide such conditions and/or structures, in view of the present disclosure, as a matter of routine experimentation, etc.

What is claimed:

1. A multilayer ceramic electronic component, comprising:
a laminate body including:
a plurality of dielectric layers laminated along a first axis,
a plurality of internal electrode layers each arranged between adjacent dielectric layers of the plurality of dielectric layers along the first axis, and
intermediate regions each arranged between the plurality of dielectric layers and the plurality of internal electrode layers, respectively,
wherein each of the plurality of dielectric layers contains barium titanate and copper,
the plurality of internal electrode layers and the intermediate regions each contain nickel and copper,
a metal concentration A (at %) of nickel in each of the intermediate regions is 3 at %<A<50 at % whereas a metal concentration B (at %) of nickel in each of the internal electrode layer is A<B,
wherein the following relationships are satisfied:
$$D 12 > D 11 , and D 11 < D 40$$
where D12 (at %) is an average metal concentration of copper in the plurality of internal electrode layers, D11 (at %) is an average metal concentration of copper in the plurality of dielectric layers, and D40 (at %) is an average metal concentration of copper in the intermediate regions, and
$$D 12 is 0.1 at \% < D 12 \leq 35 at \% , and D 11 is 0.01 at \% < D 11 < 5 at \% .$$

2. The multilayer ceramic electronic component according to claim 1, wherein an average metal concentration D40E (at %) of copper in (i) intermediate regions arranged in a set of pairs of internal electrode layers and dielectric layers located at third to tenth paired layers counted from an upper face of the laminate body in a lamination direction and in (ii) intermediate regions arranged in a set of pairs of internal electrode layers and dielectric layers located at third to tenth paired layers counted from a lower face of the laminate body in the lamination direction is higher than an average metal concentration D40M (at %) of copper in (iii) intermediate regions arranged in a set of a total of 10 paired layers of internal electrode layers and dielectric layers located in a center of the laminate body in the lamination direction.

3. The multilayer ceramic electronic component according to claim 1, wherein the average metal concentration (at %) of copper in each of the intermediate regions varies in a lamination direction of the laminate body.

4. The multilayer ceramic electronic component according to claim 2, wherein the average metal concentration (at %) of copper in each of the intermediate regions varies in a lamination direction of the laminate body.

5. The multilayer ceramic electronic component according to claim 1, wherein D40 (at %) is 0.05 at %≤D40≤15 at %.

6. The multilayer ceramic electronic component according to claim 2, wherein D40 (at %) is 0.05 at %≤D40≤15 at %.

7. A method for manufacturing a multilayer ceramic electronic component, comprising:
a raw material powder preparation step of preparing a ceramic raw material powder for forming a dielectric layer, the ceramic raw material powder containing barium titanate and copper;
a coating step of applying a slurry containing the ceramic raw material powder onto a substrate to form ceramic green sheets;
an internal electrode layer-forming step of applying an internal electrode layer slurry containing nickel and copper onto a surface of each of the ceramic green sheets by printing to form an internal electrode layer;
a pressure-bonding step of pressure-bonding a laminated body in which the ceramic green sheets each including the internal electrode layer are laminated and the internal electrode layer is interposed between the ceramic green sheets, to form a pressure-bonded laminated body;
a singulation step of singulating the pressure-bonded laminated body into pieces; and
a firing step of firing the singulated laminated body pieces,
wherein in the firing step, a rate of temperature rise from 600° C. to 1,300° C. is 30,000° C./h or higher.
